(19) United States
(12) Patent Application Publication
(10) Pub. No.: US 2026/0097669 A1
(43) Pub. Date: Apr. 9, 2026

(54) WIRELESS CHARGING APPARATUS AND METHOD CORRESPONDABLE TO VOLTAGE RANGE OF BATTERY

(71) Applicants: Hyundai Motor Company, Seoul (KR); Kia Corporation, Seoul (KR)

(72) Inventors: Min-Seong Choi, Hwaseong-si (KR); Si-Hun Yang, Hwaseong-si (KR); Sun-Ho Lee, Hwaseong-si (KR); Hyun-Wook Seong, Hwaseong-si (KR); Dong-Gyun Woo, Hwaseong-si (KR)

(21) Appl. No.: 19/230,568

(22) Filed: Jun. 6, 2025

(30) Foreign Application Priority Data
Oct. 8, 2024 (KR) 10-2024-0136639

(51) Int. Cl. B60L 53/24; B60L 53/122; B60L 53/62

(52) U.S. Cl. CPC B60L 53/24; B60L 53/122; B60L 53/62; B60L 2210/12; B60L 2210/14

(57) ABSTRACT

A wireless charging device correspondable to a can include a voltage power supply unit configured to supply DC voltage power, a filtering unit configured to generate a certain level of DC voltage power from the DC voltage power, a conversion operation unit configured to convert the certain level of DC voltage power into one of boost charging power, buck charging power, and bypass charging power or drive a vehicle during charging of the vehicle, a driving motor that serves as coupled inductance during charging, and an inverter configured to perform one of a boost converter operation mode for the boost charging power, a buck converter operation mode for the buck charging power, a bypass operation mode for the bypass charging power, and a vehicle driving mode for driving the vehicle in connection with the filtering unit, the conversion operation unit, and the driving motor during the charging.

### CROSS-REFERENCE TO RELATED APPLICATIONS

This application claims priority to Korean Patent Application No. 10-2024-0136639, filed on Oct. 8, 2024, which is incorporated herein by reference in its entirety.

### TECHNICAL FIELD

The present disclosure relates to a wireless charging apparatus.

### BACKGROUND

An inductive power transfer (IPT) system is a system for transferring power using the electromagnetic induction phenomenon between transmitting and receiving coils.

A high-voltage battery pack that is a load of a wireless charger system for an electric vehicle generally requires a broad charging voltage range and has the characteristic of a very broad fluctuation range of battery equivalent load resistance.

An output voltage of the IPT system varies depending on a coupling coefficient of transmitting and receiving power coils. In the case of wireless chargers for an electric vehicle, because the coupling coefficient k varies depending on a location of a vehicle and an operating frequency is limited, various ground assembly (GA)/vehicle assembly (VA)-side compensation circuit methods and complicated optimization control methods are required to satisfy a broad charging voltage and charging power range of a battery pack.

According to the vehicle wireless charging standard J2954 document, a frequency control range of GA/VA wireless charging units is required to range from 79 to 90 kHz (nominal: 85 kHz). In addition, the coupling coefficient k varies depending on a location of a vehicle and the operating frequency is limited. Accordingly, to satisfy the broad charging voltage and charging power range of the battery pack, there is also a method of configuring a wireless charging system by adding a battery management (BM) circuit unit.

Such a BM circuit unit has a problem of being composed of a boost circuit (i.e., a boost converter) that is a type of DC-DC converter.

In addition, a three-stage wireless charging system has a problem that the material cost and/or size are excessive compared to a two-stage wireless charging system.

In addition, the converter is classified into a BM converter for a VA-side series or parallel compensation circuit depending on whether an input capacitor is present.

### SUMMARY

The present disclosure relates to a wireless charging technology, and more specifically, to a quick wireless charging device and method correspondable to a broad voltage range of a battery using a motor system for a vehicle.

An embodiment of the present disclosure can solve the above problems and can be directed to providing a device and method capable of quick wireless charging by configuring a boost/buck converter without adding a separate converter.

An embodiment of the present disclosure can provide a device and method capable of quick wireless charging within a broad voltage range of a battery.

An embodiment of the present disclosure can provide a device and method capable of quick wireless charging by implementing a vehicle assembly (VA)-side series or parallel compensation circuit.

An embodiment of the present disclosure can provide a device capable of quick wireless charging without adding a separate converter.

In an embodiment of the present disclosure, a device can include a voltage power supply unit configured to supply DC voltage power, a filtering unit configured to generate a certain level of DC voltage power from the DC voltage power, a conversion operation unit configured to convert the certain level of DC voltage power into one of a boost charging power, a buck charging power, and a bypass charging power that uses the preset level of DC voltage power or drive a vehicle during charging of the vehicle, and an inverter configured to perform one of a boost converter operation mode for the boost charging power, a buck converter operation mode for the buck charging power, a bypass operation mode for the bypass charging power, and a vehicle driving mode for driving the vehicle in connection with the filtering unit, the conversion operation unit, and the driving motor during the charging.

The filtering unit can include a capacitor connected parallel to an outer terminal of the voltage power supply unit, and a switching element connected in series to the capacitor to activate or deactivate a function of the capacitor.

The capacitor can be an input capacitor, and when the voltage power supply unit is configured as a vehicle assembly (VA)-side series compensation circuit, the capacitor can filter a current ripple applied to an input terminal through a fully ON operation of the switching element and maintain the certain level of DC voltage power.

The switching element can be turned off in the vehicle driving mode or when the voltage power supply unit is configured as a VA-side parallel compensation circuit, and can be fully turned on when the voltage power supply unit is configured as a VA-side series compensation circuit.

The conversion operation unit can include a plurality of switching units arranged parallel to each other to operate in a complementary relationship.

In the case of the buck converter operation mode, one of the plurality of switching elements can be repeatedly turned on and off, and the rest of the plurality of switching elements can be repeatedly turned off and on to complementarily correspond to the one.

The plurality of switching units can be each composed of a single switching element.

The plurality of switching units can be each composed of a plurality of switching elements arranged parallel to each other.

One of the plurality of switching units can be repeatedly turned on and off using a phase difference at a specific angle during operation of the buck converter.

The inverter can include a lower switching block and an upper switching block that operate in a complementary relationship.

In the case of the boost converter operation mode, the lower switching block can be repeatedly turned on and off, and the upper switching block can be repeatedly turned off and on to complementarily correspond to the lower switching block.

The lower switching block can be repeatedly turned on and off using a phase difference at a specific angle.

In the case of the buck converter operation mode, the upper switching block can be fully turned on to secure a bypass path.

According to an embodiment of the present disclosure, a wireless charging device correspondable to a battery voltage range can include: a voltage power supply unit configured to supply DC voltage power, a filtering unit configured to generate a certain level of DC voltage power from the DC voltage power, a first inverter configured to convert the certain level of DC voltage power into one of a boost charging power, a buck charging power, and a bypass charging power which uses the preset level of DC voltage power or drive a vehicle during charging of the vehicle, a driving motor that serves as coupled inductance during charging of the vehicle, and a second inverter configured to perform one of a boost converter operation mode for the boost charging power, a buck converter operation mode for the buck charging power, a bypass operation mode for the bypass charging power, and a vehicle driving mode for driving the vehicle in connection with the filtering unit, the conversion operation unit, and the driving motor during the charging.

The first inverter can include a first switching unit connected to an output terminal of the filtering unit, a second switching unit connected parallel to the first switching unit and disposed at a bottom, a third switching unit connected parallel to the first switching unit, connected in series to the second switching unit with respect to a neutral point, and disposed at a top, and a fourth switching unit connected in series to the third switching unit.

The first switching unit can be fully turned on to secure a bypass path in a closed end winding (CEW) operation mode or the boost converter operation mode among the vehicle driving modes.

The first switching unit can repeatedly turn on and off a switching element using a phase difference at a specific angle in the buck converter operation mode.

The second switching unit can repeatedly turn on and off a switching element in an open end winding (OEW) operation mode among the vehicle driving modes and can be repeatedly turned off and on in a complementary relationship with the first switching unit in the buck converter operation mode.

The fourth switching unit can be fully turned on in the vehicle driving mode and prevents a voltage of an input terminal from being bypassed to a battery side in the buck converter operation mode.

According to an embodiment of the present disclosure, a wireless charging method correspondable to a battery voltage range can include: receiving, by a controller, a wireless charging operation request, performing, by the controller, a switching operation for boost or buck depending on whether a vehicle assembly (VA)-side compensation circuit is a series compensation circuit or a parallel compensation circuit, estimating, by the controller, a coupling coefficient through an input voltage of a VA-side boost converter or buck converter or a current value that has passed a rectifier after the GA-side inverter is operated, calculating an optimal point for each battery condition according to the coupling coefficient, and executing a boost converter operation mode or a buck converter operation mode to charge a battery according to the optimal point.

According to an embodiment of the present disclosure, it can be possible to implement the quick wireless charging system by adding some elements without adding a separate converter using the conventional motor system for a vehicle.

According to an embodiment of the present disclosure, it can be possible to perform the charging operation with the optimal efficiency within the broad voltage range of the battery.

According to an embodiment of the present disclosure, it can be possible to implement the VA-side series compensation circuit or parallel compensation circuit.

### BRIEF DESCRIPTION OF THE DRAWINGS

FIG. 1 is a circuit diagram of a wireless charging device using a single-stage inverter structure according to an example embodiment of the present disclosure.

FIG. 2 is a circuit diagram of a wireless charging device using a single-stage inverter structure according to an example embodiment of the present disclosure.

FIG. 3 is a circuit diagram of a wireless charging device using a two-stage inverter structure according to an example embodiment of the present disclosure.

FIG. 4A is a circuit diagram illustrating a series compensation circuit according to an example embodiment of the present disclosure.

FIG. 4B is a parallel compensation circuit according to an example embodiment of the present disclosure.

FIG. 5 is a flowchart illustrating an operation mechanism according to an example embodiment of the present disclosure.

FIGS. 6 and 7 are graphs illustrating simulation results according to an example embodiment of the present disclosure.

### DETAILED DESCRIPTION OF ILLUSTRATIVE EMBODIMENTS

The above-described features and advantages of example embodiments of the present disclosure will be described below in detail with reference to the accompanying drawings, and thus those skilled in the art to which the present disclosure pertains will be able to easily carry out the technical spirit of the present disclosure. In describing example embodiments of the present disclosure, when it is determined that a detailed description of known technology related to the present disclosure may unnecessarily obscure the gist of the present disclosure, a detailed description thereof can be omitted.

Hereinafter, example embodiments according to the present disclosure will be described in detail with reference to the accompanying drawings. In the drawings, same reference numerals can be used to denote same or similar components.

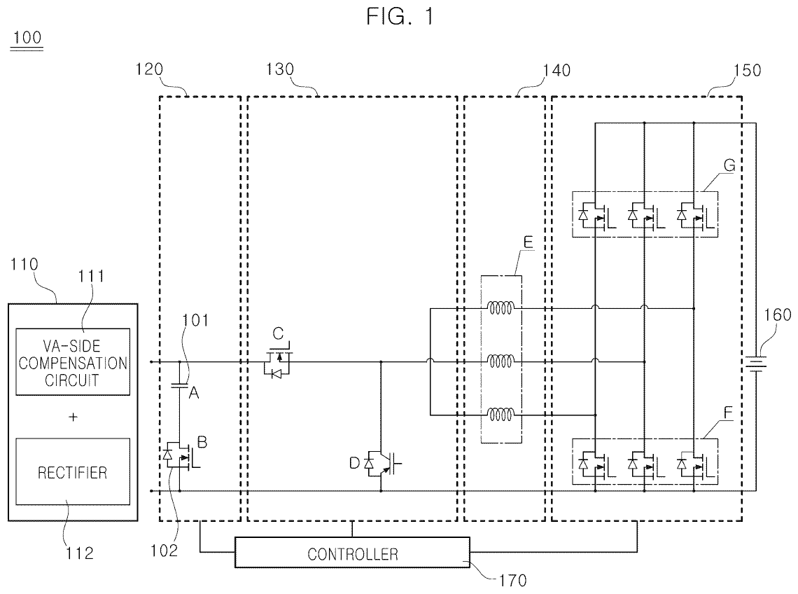

FIG. 1 is a circuit diagram of a wireless charging device 100 using a single-stage inverter structure according to an example embodiment of the present disclosure. Referring to FIG. 1, a wireless charging device 100 may include a voltage power supply unit 110, a filtering unit 120, a conversion operation unit 130, a driving motor 140, an inverter 150, a battery 160, a controller 170, and the like.

The voltage power supply unit 110 can serve to include a VA-side compensation circuit 111 and a rectifier 112 to supply AC voltage power. The VA-side compensation circuit 111 may be a series compensation circuit or a parallel compensation circuit connected to an output terminal of a transformer (not illustrated). FIG. 1 illustrates an example of such a series compensation circuit or a parallel compensation circuit. This will be described below.

The rectifier 112 can serve to convert AC voltage power into DC voltage power. To this end, the rectifier 112 may include a rectifier circuit.

The filtering unit 120 can serve to filter the DC voltage power from the rectifier 112 and generate a certain level of DC voltage power. To this end, a DC power generation unit 120 can be composed of a capacitor A 101 connected in parallel to the output terminal of the voltage power supply unit 110 and a switching element B 102 connected in series with the capacitor A 101.

When the VA-side series compensation circuit is configured as an input capacitor of a boost or buck converter, the capacitor A 101 can serve to filter a current ripple applied to an input terminal through a fully ON operation of the switching element B and maintain a certain level of voltage. The fully ON can refer to maintaining an indefinite time ON state when there is no change.

The switching element B 102 can be a switch for activating/deactivating the function of the capacitor and can be turned off in a vehicle traveling mode and when configured as a VA-side parallel compensation circuit, and the switching element B 102 can be fully turned on when configured as a series compensation circuit.

As a switching element 102, semiconductor switching elements such as a field effect transistor (FET), a metal oxide semiconductor FET (MOSFET), an insulated gate bipolar mode transistor (IGBT), and a power rectifier diode, a thyristor, a gate turn-off (GTO) thyristor, and a triode for alternating current (TRIAC), a silicon controlled rectifier (SCR), an IC circuit, and the like, can be used.

In particular, in the case of a semiconductor switching element, a bipolar or power MOSFET element and the like may be used. Power MOSFET elements can operate at high voltage and high current, and unlike general MOSFETs, can have a double-diffused metal oxide semiconductor (DMOS) structure.

The conversion operation unit 130 can serve to execute a conversion operation of stepping down and converting DC voltage power into buck charging power or stepping up and converting DC voltage power into boost charging power. The conversion operation unit 130 can be composed of a switching unit C connected to an output terminal of the filtering unit 120 and a switching unit D connected parallel to the switching unit C.

The driving motor 140 can perform a motor driving function when the vehicle is driven with a mutual inductance component of motor windings. When represented as an equivalent circuit, the driving motor 140 can be composed of three inductors E arranged parallel to each other. Accordingly, the driving motor 140 can perform a driving function when the vehicle is driven and can serve as a coupled inductance during charging. That is, electric energy may be stored in the inductor E and used for stepping up.

The inverter 150 can perform a motor control operation when the vehicle is driven and perform a boost or buck converter operation during charging. That is, a boost converter operation mode or a buck converter operation mode can be performed through the conversion operation unit 130 and the driving motor 140. To this end, the inverter 150 can be composed of a lower switching block F and an upper switching block G.

Generally, two switching elements can be connected to one phase in the inverter, and a direction of a phase current can be controlled depending on whether a switching element located at the top is turned on or a switching element located at the bottom is turned on.

The battery 160 can include battery cells (not illustrated) configured in series and/or parallel, and the battery cells may be high-voltage battery cells for an electric vehicle, such as nickel metal battery cells, lithium ion battery cells, lithium polymer battery cells, lithium sulfur battery cells, sodium sulfur battery cells, and all-solid-state battery cells. In general, a high-voltage battery can be a battery used as a power source for moving electric vehicles and can have a high voltage of 100 V or more. However, an embodiment of the present disclosure is not necessarily limited thereto, and low-voltage batteries are also possible.

The controller 170 can be connected to the filtering unit 120, the conversion operation unit 130, and the inverter 150 to control the on/off of the switching elements. The controller 170 can serve to execute a charging instruction after receiving the charging instruction from an upper-level controller (not illustrated) and transmit a processing signal to the upper-level controller. A pulse width modulation (PWM) control method can be used for, and is generally used for, the on/off control of the switching elements, but a pulse frequency modulation (PFM) control method or a combined method thereof may also be used.

To this end, the controller 170 may include a microprocessor, an electronic circuit, a memory, a voltage sensor, a current sensor, and the like.

The circuit diagram illustrated in FIG. 1 is a circuit diagram of a single-phase buck inverter and a three-phase boost converter using a single-stage inverter. Accordingly, the operation and role according to use conditions can be as follows.
(a) Vehicle driving mode conditions:
A: Not used, B: OFF, C: OFF, D: OFF, E: serve as a driving motor, F: motor control using a PWM control method, G: motor control using a PWM control method.
(b) Connection to VA-side series compensation circuit and boost use conditions:
A: a current is filtered and DC voltage power is generated ON, C: OFF, D: OFF, E: serve as a coupled inductor, F: three-phase interleaved PWM operation, G: complementary operation (i.e., synchronization control) with F or OFF operation (i.e., a diode mode).

Here, the three-phase interleaved PWM operation can be an operation of covering 360° with a phase shift of 120°. The PWM operation can be an operation of repeating the on/off of the switching element.

The complementary operation can refer to the on/off being alternated. The supplementary description can be as follows. G is ON when F is OFF, and G is OFF when F is ON.

For the circuit illustrated in FIG. 1 to be operated as a boost converter, an interleaved PWM operation and the complementary operation can be performed.
(c) Connection to VA-side series compensation circuit and buck use conditions:
A: a current is filtered and DC voltage power is generated, B: ON, C: PWM operation, D: complementary operation with C or an OFF operation (i.e., a diode mode), E: serve as a coupled inductor, F: OFF, G: ON.

The switching element of the switching unit D and the switching element of the switching unit C can be operated complementarily, the lower switching block F can be turned off and the upper switching block G can be turned on, and the circuit can be operated as the buck inverter. That is, the upper switching block G can be fully turned on to secure a bypass path.
(d) Connection to the VA-side series compensation circuit and wireless charging bypass use conditions:
A: a current is filtered and DC voltage power is generated, B: ON, C: ON, D: OFF, E: serve as a coupled inductor (i.e., serve as an output filter), F: OFF, G: ON.

In the case of (d), the circuit can be performed in a bypass operation mode. Accordingly, a certain level of DC voltage power generated by the filtering unit 120 without stepping down or stepping up can be supplied to the battery 160 as charging power.
(e) Connection to VA-side parallel compensation circuit and wireless charging boost use conditions:
A: Not used, B: OFF, C: ON, D: OFF, E: serve as a coupled inductor, F: three-phase interleaved PWM operation, G: complementary operation (synchronization control) with F or OFF operation (i.e., a diode mode).
(e) is similar to (b), an only difference is a case in which the VA-side compensation circuit 111 of the voltage power supply unit 110 is a parallel compensation circuit.
(f) Connection to VA-side parallel compensation circuit and buck use conditions:
(f) is similar to (c), an only difference is a case in which the VA-side compensation circuit 111 of the voltage power supply unit 110 is a parallel compensation circuit.
(g) Connection to the VA-side series compensation circuit and wireless charging bypass use conditions:
A: Not used, B: OFF, C: ON, D: OFF, E: serve as a coupled inductor (i.e., serve as an output filter), F: OFF, G: ON.
(g) is similar to (d), an only difference is a case in which the VA-side compensation circuit 111 of the voltage power supply unit 110 is a parallel compensation circuit.

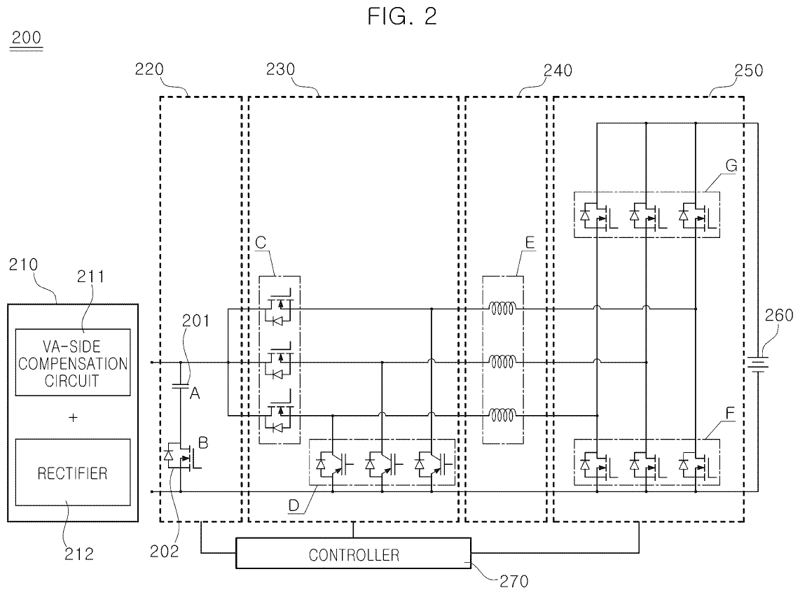

FIG. 2 is a circuit diagram of a wireless charging device 200 using a single-stage inverter structure according to an example embodiment of the present disclosure. Referring to FIG. 2, the wireless charging device 200 may include a voltage power supply unit 210, a filtering unit 220, a conversion operation unit 230, a driving motor 240, an inverter 250, a battery 260, a controller 270, and the like. These components can perform functions similar to those of the voltage power supply unit 110, the filtering unit 120, the conversion operation unit 130, the driving motor 140, the inverter 150, the battery 160, the controller 170, and the like illustrated in FIG. 1.

However, a difference can be that switching units C and D configured in the conversion operation unit 230 can be each composed of three switching elements connected parallel to each other. That is, three switching elements can be configured parallel to each other in the switching unit C, and these three switching elements can be connected to the output terminals of the filtering units 120 and 220.

The switching unit D also can have three switching elements configured parallel to each other, and these three switching elements can be connected parallel to the three switching elements configured in the switching unit C.

The circuit diagram illustrated in FIG. 2 is a circuit diagram of a three-phase buck inverter and a three-phase boost converter using a single-stage inverter. Accordingly, the operation and role according to use conditions can be as follows.
(a) Vehicle driving mode conditions:
A: Not used, B: OFF, C: OFF, D: OFF, E: serve as a driving motor, F: motor control using a PWM control method, G: motor control using a PWM control method.
(b) Connection to VA-side series compensation circuit and boost use conditions:
A: a current is filtered and DC voltage power is generated, B: ON, C: OFF, D: OFF, E: serve as a coupled inductor, F: three-phase interleaved PWM operation, G: complementary operation (i.e., synchronization control) with F or OFF operation (i.e., a diode mode).

Here, the three-phase interleaved PWM operation can be an operation of covering 360° with a phase shift of 120°. A PWM operation can be an operation of repeating the on/off of the switching element.

The complementary operation can refer to the on/off being alternated.

The supplementary description can be as follows: G is ON when F is OFF, and G is OFF when F is ON.

For the circuit illustrated in FIG. 2 to be operated as a boost converter, an interleaved PWM operation and the complementary operation can be performed.
(c) Connection to VA-side series compensation circuit and buck use conditions:
A: a current is filtered and DC voltage power is generated, B: ON, C: three-phase interleaved PWM operation, D: complementary operation with C or an OFF operation (i.e., a diode mode), E: serve as a coupled inductor, F: OFF, G: ON.

The three switching elements of the switching unit D and the three switching elements of the switching unit C can be repeatedly operated complementarily, the lower switching block F can be turned off and the upper switching block G can be turned on, and the circuit can be operated as the buck inverter.
(d) Connection to the VA-side series compensation circuit and wireless charging bypass use conditions:
A: a current is filtered and DC voltage power is generated, B: ON, C: ON, D: OFF, E: serve as a coupled inductor (i.e., serve as an output filter), F: OFF, G: ON.

In the case of (d), the circuit can be performed in a bypass operation. Accordingly, a certain level of DC voltage power generated by the filtering unit 220 without stepping down or stepping up can be supplied to the battery 160 as charging power.
(e) Connection to VA-side parallel compensation circuit and wireless charging boost use conditions:
A: Not used, B: OFF, C: ON, D: OFF, E: serve as a coupled inductor, F: three-phase interleaved PWM operation, G: complementary operation (synchronization control) with F or OFF operation (i.e., a diode mode).
(e) is similar to (b), an only difference is a case in which the VA-side compensation circuit 111 of the voltage power supply unit 110 is a parallel compensation circuit.
(f) Connection to VA-side parallel compensation circuit and buck use conditions:
(f) is similar to (c), an only difference is a case in which the VA-side compensation circuit 111 of the voltage power supply unit 110 is a parallel compensation circuit.
(g) Connection to the VA-side series compensation circuit and wireless charging bypass use conditions:
A: Not used, B: OFF, C: ON, D: OFF, E: serve as a coupled inductor (i.e., serve as an output filter), F: OFF, G: ON.
(g) is similar to (d), an only difference is a case in which the VA-side compensation circuit 111 of the voltage power supply unit 110 is a parallel compensation circuit.

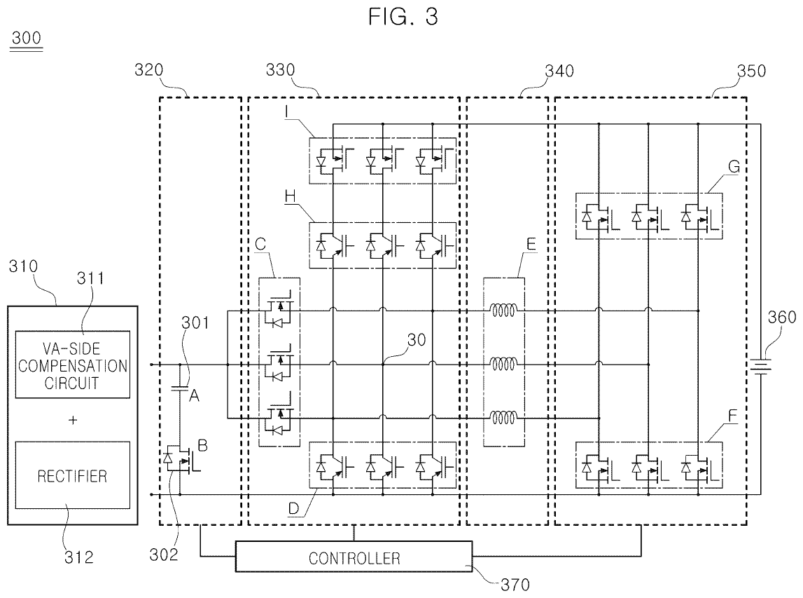

FIG. 3 is a circuit diagram of a wireless charging device 300 using a two-stage inverter structure according to an example embodiment of the present disclosure. Referring to FIG. 3, the wireless charging device 300 may include a voltage power supply unit 310, a filtering unit 320, a first inverter 330, a driving motor 340, a second inverter 350, a battery 360, a controller 370, and the like. These components can perform functions similar to those of the voltage power supply unit 210, the filtering unit 220, the conversion operation unit 230, the driving motor 240, the inverter 250, the battery 260, the controller 270, and the like illustrated in FIG. 2.

However, a difference is that a two-stage inverter structure composed of the first inverter 330 and the second inverter 350 is provided. The first inverter 330 can have a function of the conversion operation unit 230 illustrated in FIG. 2 along with the function of the inverter.

That is, the first inverter 330 can be composed of the first to fourth switching units C, D, H, and I. That is, the first inverter 330 may include a first switching unit C connected to an output terminal of the filtering unit 320, a second switching unit D connected parallel to the first switching unit C and disposed at the bottom, a third switching unit H connected parallel to the first switching unit C, connected in series to the second switching unit D with respect to a neutral point 30, and disposed at the top, and a fourth switching unit I connected in series to the third switching unit H.

Three switching elements can be configured parallel to each other in the first switching unit C, and these three switching elements can be connected to the output terminals of the filtering units 120 and 220.

The first switching unit C can be fully turned on in a closed-end winding (CEW) operation mode or a boost converter operation mode among the vehicle driving modes to secure a bypass path. The first switching unit C can perform a three-phase interleaved PWM operation with a phase difference of 120° in a buck converter operation mode.

The second switching unit D can serve to perform a motor control PWM operation in an open-end winding (OEW) operation mode among the vehicle driving modes and perform a PWM operation in a complementary relationship with the first switching unit C in the buck converter operation mode.

The second switching unit D and the third switching unit H each can have three switching elements configured parallel to each other, and these three switching elements can be connected parallel to the three switching elements configured in the first switching unit C.

The second switching unit D and the third switching unit H can correspond to the lower switching block F and the upper switching block G configured in the second inverter 150, respectively. That is, the neutral points 30 can be connected.

Accordingly, the controller 370 may execute the CEW operation mode in which the driving motor 340 is driven by one inverter 330 or 350 or the OEW operation mode in which the driving motor 340 is driven by the two inverters 330 and 350. The CEW operation mode and the OEW operation mode can have different voltage use rates of the inverter.

The fourth switching unit I can be connected in series to the third switching unit H and can be fully turned on in the vehicle driving mode to configure a two-stage motor system. The fourth switching unit I can be turned off in the converter operation mode. In particular, in the buck converter mode operation, the fourth switching unit I can serve to prevent an input terminal voltage from being bypassed to the battery 360 side.

The switching element of the fourth switching unit I may be an n-channel MOSFET, and the switching element of the third switching unit H may be an IGBT. Of course, it is only illustrative and may be combined in various ways.

The circuit diagram illustrated in FIG. 3 is a circuit diagram of a three-phase buck inverter and a three-phase boost converter using a two-stage inverter. Accordingly, the operation and role according to use conditions can be as follows.
(a) Vehicle driving mode conditions:
A: Not used, B: OFF, C: ON in the CEW operation mode, OFF in the OEW operation mode, D: OFF in the CEW operation mode, the motor control PWM in the OEW operation mode, E: serve as a driving motor, F: motor control using a PWM control method, G: motor control using a PWM control method, H: OFF in the CEW operation mode, the motor control PWM in the OEW operation mode, I: ON.
(b) Connection to VA-side series compensation circuit and boost use conditions:
A: a current is filtered and DC voltage power is generated, B: ON, C: OFF, D: OFF, E: serve as a coupled inductor, F: three-phase interleaved PWM operation, G: complementary operation (i.e., synchronization control) with F or OFF operation (i.e., a diode mode), H: OFF, I: OFF.

Here, the three-phase interleaved PWM operation can be an operation of covering 360° with a phase shift of 120°. A PWM operation can be an operation of repeating the on/off of the switching element.

The complementary operation can refer to the on/off being alternated. The supplementary description can be as follows: G is ON when F is OFF, and G is OFF when F is ON.

For the circuit illustrated in FIG. 3 to be operated as a boost converter, an interleaved PWM operation and the complementary operation can be performed.
(c) Connection to VA-side series compensation circuit and buck use conditions:
A: a current is filtered and DC voltage power is generated, B: ON, C: three-phase interleaved PWM operation, D: complementary operation with C or an OFF operation (i.e., a diode mode), E: serve as a coupled inductor, F: OFF, G: ON, H: OFF, I: OFF.

The three switching elements of the switching unit D and the three switching elements of the switching unit C can be repeatedly operated complementarily, the lower switching block F can be turned off and the upper switching block G can be turned on, and the circuit can be operated as the buck inverter.
(d) Connection to the VA-side series compensation circuit and wireless charging bypass use conditions:
A: a current is filtered and DC voltage power is generated, B: ON, C: ON, D: OFF, E: serve as a coupled inductor (i.e., serve as an output filter), F: OFF, G: ON, H: OFF, I: OFF.

In the case of (d), the circuit can be performed in a bypass operation. Accordingly, a certain level of DC voltage power generated by the filtering unit 320 without stepping down or stepping up can be supplied to the battery 360 as charging power. In the bypass operation, a bypass charging power that uses the certain level of DC voltage power can be supplied to the battery 360.
(e) Connection to VA-side parallel compensation circuit and wireless charging boost use conditions:
A: Not used, B: OFF, C: ON, D: OFF, E: serve as a coupled inductor, F: three-phase interleaved PWM operation, G: complementary operation (synchronization control) with F or OFF operation (i.e., a diode mode), H: OFF, I: OFF.
(e) is similar to (b), an only difference is a case in which the VA-side compensation circuit 111 of the voltage power supply unit 110 is a parallel compensation circuit.
(f) Connection to VA-side parallel compensation circuit and buck use conditions:
(f) is similar to (c), an only difference is a case in which the VA-side compensation circuit 111 of the voltage power supply unit 110 is a parallel compensation circuit.
(g) Connection to the VA-side series compensation circuit and wireless charging bypass use conditions:
A: Not used, B: OFF, C: ON, D: OFF, E: serve as a coupled inductor (i.e., serve as an output filter), F: OFF, G: ON, H: OFF, I: OFF.
(g) is similar to (d), an only difference is a case in which the VA-side compensation circuit 111 of the voltage power supply unit 110 is a parallel compensation circuit.

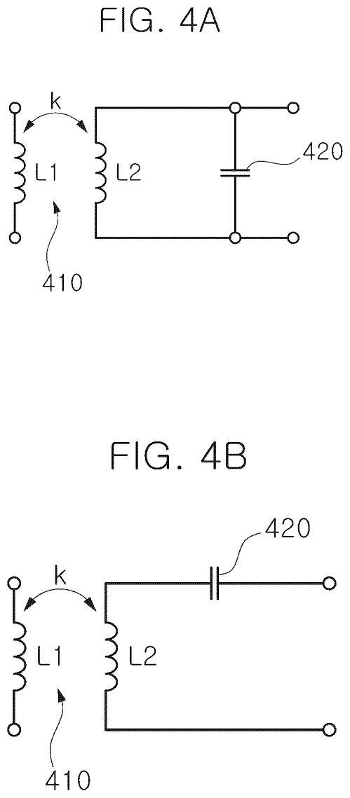

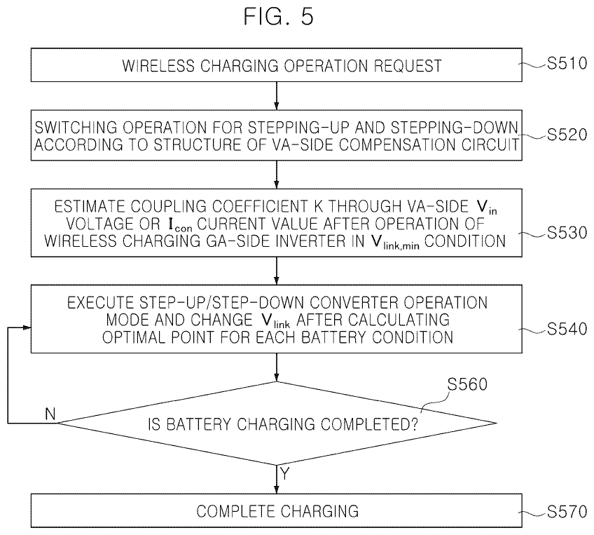

FIG. 4A is a circuit diagram illustrating a series compensation circuit according to an example embodiment of the present disclosure. FIG. 4B is a parallel compensation circuit according to an example embodiment of the present disclosure.

A transformer 410 illustrated in FIG. 4A is composed of a primary coil inductor L1 and a secondary coil inductor L2, and a capacitor 420 is configured parallel to the secondary coil inductor L2. The capacitor illustrated in FIG. 4B is connected in series with the secondary coil inductor. The coupling coefficient k refers to a ratio of a magnetic flux coupled with a different coil.

The primary coil inductor L1 side of the transformer 410 can be composed of a GA-side inverter (not illustrated) and a GA-side compensation circuit.

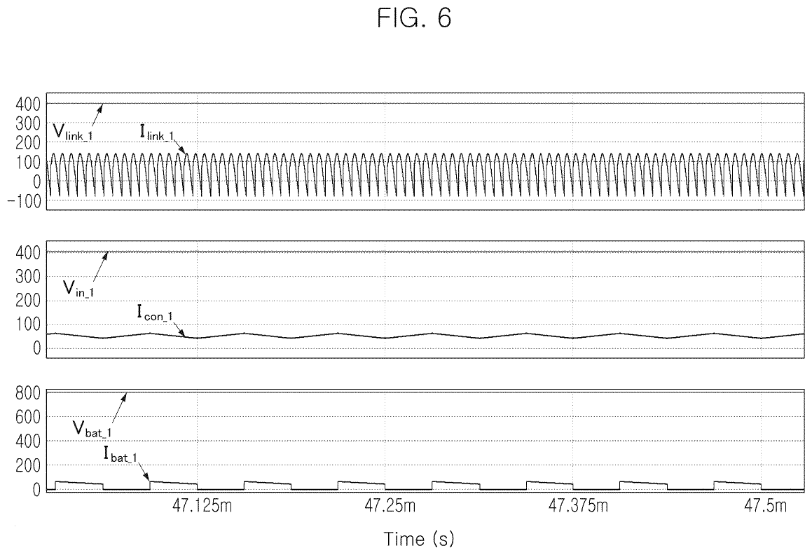

FIG. 5 is a flowchart illustrating an operation mechanism according to an example embodiment of the present disclosure. Referring to FIG. 5, when there is a wireless charging operation request from a driver, the controllers 170, 270, and 370 can perform the wireless charging operation (operation S510).

Thereafter, the controllers 170, 270, and 370 can operate a switch for boosting (i.e., stepping-up) or buck (i.e., stepping-down) according to a structure of the VA-side compensation circuit (operation S520). That is, in the case of the series compensation circuit, a switch B can be turned on so that the bypass operation mode is executed. In the case of the parallel compensation circuit, the switch B can be turned off so that the bypass operation mode is executed.

Thereafter, after the wireless charging GA-side inverter operates under the V_{link,min} condition, the coupling coefficient k value can be estimated through a VA-side Vᵢₙ voltage or Icon current value (operation S530). That is, the V_{link,min} condition may be that, when a controllable link voltage Vₗᵢₙₖ range ranges from about 500 to 800 V, the V_{link,min} value is about 500 V.

The coupling coefficient k value may be estimated through an input voltage Vᵢₙ input to an input terminal of the boost converter or the buck converter or an average current I_{con} passing through the rectifiers 112, 212, and 312. That is, when a power transmission operation is performed at a specific frequency (e.g., 85 kHz) at V_{link,min}, the coupling coefficient k of the transformer may be estimated through the measured values and phases of the voltages/currents at the input and output terminals.

Thereafter, after an optimal point for each battery condition can be calculated, the boost converter operation mode or the buck converter operation mode can be executed and Vₗᵢₙₖ can be changed (operation S540). That is, boost/buck ratios of the boost/buck converters that may operate at an optimal efficiency point can be determined according to the coupling coefficient k. The boost/buck ratios of the boost/buck converters can be determined by referring to the estimated k value, battery voltage, battery demand power, and the like, and the boost/buck converters can be operated to perform a battery charging operation.

Thereafter, it can be checked whether battery charging is completed (operation S560). Whether the battery is fully charged may be checked using a state of charge (SoC). To this end, the batteries 160, 260, and 360 may include a battery management system (BMS) (not illustrated).

The BMS can serve to increase energy efficiency and extend a life by optimizing management of a battery for an eco-friendly vehicle. It can be possible to increase the stability and reliability of the battery by monitoring a voltage, current, and temperature of the battery in real time and preventing excessive charging and discharging. To this end, the BMS may include various sensors, microprocessors, switching elements, cell balancers, and the like.

In operation S560, as the result of the check, when battery charging is completed, charging can be completed (operation S570).

In contrast, in operation S560, as the result of the check, when the battery charging is not completed, operations S540 to S560 can proceed.

In the configuration of the wireless charging devices 100, 200, and 300, output load resistance RL may be calculated by the relationship between an output voltage and an output current, and the load resistance is one of important variables that determine the overall efficiency of the wireless power transmission system.

Input power and output power of ideal boost/buck converters are the same, and input impedance may be converted according to the relationship formula between input and output terminals. When the output load resistance is RL, the output voltage is Vo, and the input voltage is Vin, the input impedance in the boost converter or buck converter illustrated in FIGS. 1 to 3 becomes Rin=(Vin/Vo)²×RL.

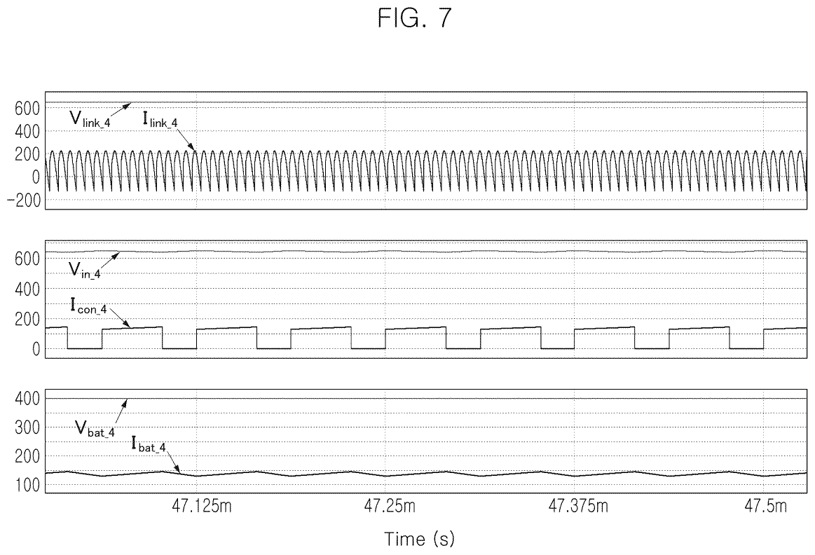

FIGS. 6 and 7 are graphs illustrating simulation results according to an embodiment of the present disclosure. FIGS. 6 and 7 are examples of the operation simulation of the boost converter in which a motor system is converted into a single-phase equivalent converter.

In FIGS. 6 and 7, Vₗᵢₙₖ denotes a link voltage, Iₗᵢₙₖ denotes a link current, V_{bat} denotes a battery voltage, and I_{bat} denotes a battery current.

The operations of the method or algorithm described in relation to the example embodiments disclosed herein may be implemented in the form of program commands that may be executed through various computer devices such as a microprocessor, a processor, and a CPU and stored in a computer-readable medium. The computer-readable medium may include program (command) codes, data files, data structures, etc. alone or in combination.

What is claimed is:

1. A wireless charging device comprising:
a voltage power supply unit configured to supply DC voltage power;
a filtering unit configured to generate a first level of DC voltage power from the DC voltage power;
a conversion operation unit configured to convert the first level of DC voltage power into one of a boost charging power, a buck charging power, and a bypass charging power that uses the first level of DC voltage power or drive a vehicle during charging of the vehicle;
a driving motor that serves as coupled inductance during the charging; and
an inverter configured to perform one of a boost converter operation mode for the boost charging power, a buck converter operation mode for the buck charging power, a bypass operation mode for the bypass charging power, and a vehicle driving mode for driving the vehicle in connection with the filtering unit, the conversion operation unit, and the driving motor during the charging.

2. The wireless charging device of claim 1, wherein the filtering unit comprises:
a capacitor connected parallel to an outer terminal of the voltage power supply unit; and
a switching element connected in series to the capacitor in a configuration to activate or deactivate a function of the capacitor.

3. The wireless charging device of claim 2, wherein the capacitor comprises an input capacitor, the wireless charging device being configured such that the capacitor filters a current ripple applied to an input terminal through a fully ON operation of the switching element and maintains the first level of DC voltage power, based on the voltage power supply unit being configured as a vehicle assembly (VA)-side series compensation circuit.

4. The wireless charging device of claim 2, wherein the wireless charging device is configured such that the switching element is turned off in the vehicle driving mode or based on the voltage power supply unit being configured as a VA-side parallel compensation circuit, and the switching element is fully turned on based one the voltage power supply unit being configured as a VA-side series compensation circuit.

5. The wireless charging device of claim 1, wherein the conversion operation unit includes a plurality of switching units arranged parallel to each other in a configuration to operate in a complementary relationship.

6. The wireless charging device of claim 5, wherein the wireless charging device is configured such that, in the buck converter operation mode, one of the plurality of switching elements is repeatedly turned on and off, and the rest of the plurality of switching elements are repeatedly turned off and on to complementarily correspond to the one.

7. The wireless charging device of claim 5, wherein each of the plurality of switching units includes a single switching element.

8. The wireless charging device of claim 5, wherein each of the plurality of switching units includes of a plurality of switching elements arranged parallel to each other.

9. The wireless charging device of claim 8, wherein the wireless charging device is configured such that one of the plurality of switching units is repeatedly turned on and off using a phase difference at a preset angle during operation of the buck converter.

10. The wireless charging device of claim 1, wherein the inverter includes a lower switching block and an upper switching block that are configured to operate in a complementary relationship.

11. The wireless charging device of claim 10, wherein the wireless charging device is configured such that, in the boost converter operation mode, the lower switching block is repeatedly turned on and off, and the upper switching block is repeatedly turned off and on to complementarily correspond to the lower switching block.

12. The wireless charging device of claim 11, wherein the wireless charging device is configured such that the lower switching block is repeatedly turned on and off using a phase difference at a preset angle.

13. The wireless charging device of claim 10, wherein the wireless charging device is configured such that, in the buck converter operation mode, the upper switching block is fully turned on to secure a bypass path.

14. A wireless charging device comprising:
a voltage power supply unit configured to supply DC voltage power;
a filtering unit configured to generate a first level of DC voltage power from the DC voltage power;
a first inverter configured to convert the first level of DC voltage power into one of a boost charging power, a buck charging power, and a bypass charging power that uses the first level of DC voltage power or driving a vehicle using a two-stage inverter structure to charge the vehicle;
a driving motor that serves as coupled inductance during charging of the vehicle; and
a second inverter configured to perform one of a boost converter operation mode for the boost charging power, a buck converter operation mode for the buck charging power, a bypass operation mode for the bypass charging power, and a vehicle driving mode for driving the vehicle in connection with the filtering unit, the conversion operation unit, and the driving motor during the charging.

15. The wireless charging device of claim 14, wherein the first inverter comprises:
a first switching unit connected to an output terminal of the filtering unit;
a second switching unit connected parallel to the first switching unit;
a third switching unit connected parallel to the first switching unit, and connected in series to the second switching unit with respect to a neutral point; and
a fourth switching unit connected in series to the third switching unit.

16. The wireless charging device of claim 15, wherein the first switching unit is configured to be fully turned on to secure a bypass path in a closed end winding (CEW) operation mode or the boost converter operation mode among the vehicle driving modes.

17. The wireless charging device of claim 15, wherein the first switching unit is configured to repeatedly turn on and off a switching element using a phase difference at a preset angle in the buck converter operation mode.

18. The wireless charging device of claim 15, wherein the second switching unit is configured to repeatedly turn on and off a switching element in an open end winding (OEW) operation mode among the vehicle driving modes and be repeatedly turned off and on in a complementary relationship with the first switching unit in the buck converter operation mode.

19. The wireless charging device of claim 15, wherein the fourth switching unit is configured to be fully turned on in the vehicle driving mode and prevent a voltage of an input terminal from being bypassed to a battery side in the buck converter operation mode.

20. A wireless charging method comprising:
receiving a wireless charging operation request;
performing a switching operation for boost or buck depending on whether a vehicle assembly (VA)-side compensation circuit is a series compensation circuit or a parallel compensation circuit;
estimating a coupling coefficient through an input voltage of a VA-side boost converter or a VA-side buck converter or a current value that has passed a rectifier after the GA-side inverter is operated;
determining an optimal point for each battery condition according to the coupling coefficient; and
executing a boost converter operation mode or a buck converter operation mode to charge a battery according to the optimal point.
